(19) United States
(12) Patent Application Publication
(10) Pub. No.: US 2017/0059700 A1
(43) Pub. Date: Mar. 2, 2017

(54) Error Correction In Low-Cost Off-Axis Doppler Radar Readings

(71) Applicants: Jose J. Doval, Escondido, CA (US); Kirt Alan Winter, San Diego, CA (US)

(72) Inventors: Jose J. Doval, Escondido, CA (US); Kirt Alan Winter, San Diego, CA (US)

(21) Appl. No.: 15/151,027

(22) Filed: May 10, 2016

Related U.S. Application Data
(60) Provisional application No. 62/211,594, filed on Aug. 28, 2015.

(51) Int. Cl. G01S 13/58

(52) U.S. Cl. CPC G01S 13/581

(57) ABSTRACT

A method for correcting Doppler shift-based speed measurements of a projectile where the correction is based upon a two-parameter model for the projectile speed. In one example application, the method is used for correcting the well-known “cosine” measurement error endemic in Doppler shift-based speed measurements is accomplished by comparing the received projectile speed data with parametric curves that are computed in a low-cost microprocessor, and selecting a set of two parametric curves that bound the received projectile data within a sufficiently narrow parametric range so that the initial projectile speed can be computed with the desired accuracy.

### CROSS-REFERENCE TO RELATED APPLICATIONS

This application claims priority to U.S. Provisional application 62/211,594, filed on 28 Aug. 2015, titled “Error Correction in Low-Cost Off-Axis Doppler Radar Readings,” by the same inventors and currently pending.

### BACKGROUND OF THE INVENTION

Technical Field

The present invention relates to sensors used to capture parameters related to athletic performance in a sporting or other activity and improved analysis of the data from those sensors. In particular this application describes a method for correcting Doppler shift-based measurements of the speed at which a sports projectile—such as a baseball, a tennis ball or a hockey puck—is delivered by an athlete, resulting in a more accurate measurement of that speed.

Related Background Art

The use of electronic sensors in sports and other activities to make measurements of an athlete's performance is ubiquitous. Sensors on bicycles now measure speed, power output, pedaling cadence and heart rate of the rider. Video is being used to capture the swing motion of batters, golfers and tennis players. Slow motion replay of a baseball pitcher's motion or a batter's swing has been used for entertainment, instruction and training. Sensors and analyses of sensor data are used in a wide variety of sports and activities including for example: baseball, golf, tennis and other racket sports, football, gymnastics, dance and for help in rehabilitation of the people who have lost limbs and are learning how to walk or perform other activities with prosthetics.

Virtually all athletic skill development is an iterative process. One must perform a task, measure the outcome of the task and then analyze one's technique in order to improve. If any of these steps are missing in a training environment, this at best hinders the development of the athlete and at worst, prevents it. Young athletes who strive to compete at the highest levels in their sport are generally very self-motivated. They are the ones who work hardest during practice, stay after practice for extra repetitions and often train alone. Measurement is one of the key feedback mechanisms for specific skill development. In baseball, the development of athletes for the position of pitcher requires specialized skill development. In addition to general skills such as fielding, batting and base running, potential pitchers are subjected to exercises and drills that help them to control the speed and trajectory of baseballs that they deliver to a batter of the opposing team. Accurate and repeatable measurement of the speed of a pitched baseball has, therefore, always been a key element of pitcher development. Small, hand-held radar units (so-called radar “guns”) have long been used to measure the velocity of a pitched baseball. These systems are compact and light weight and are easily used by members of a baseball team's coaching staff to measure the speed of a pitched baseball with relative accuracy. It has been well established, however, that the accuracy of the radar gun speed measurement is significantly dependent on the position of the instrument relative to the trajectory of the pitch. In particular, positioning of the instrument away from the primary axis of the trajectory causes an error in the speed measurement proportional to the cosine of the angle between the axis of the pitch and the detection axis of the instrument.

The specific form of this “cosine” error is such that it suggests the existence of a general solution that might be achieved by applying signal processing techniques to the raw speed data from the radar system. Such signal processing solutions are found to be complex, however, typically requiring curve fitting of the radar data over at least several segments of the overall trajectory. This level of signal processing demands the use of expensive, high speed digital electronic components that also consume significant amounts of power from the portable unit's battery. Thus, there is a need for a signal processing method for correction of the “cosine” error in low-cost Doppler radar units that can be accomplished with more economical components and with lower power consumption.

### DISCLOSURE OF THE INVENTION

A method is described that addresses the deficiencies described above. A conventional radar “gun” is modified to accomplish signal processing of the Doppler speed data that provides for automatic correction of the “cosine” measurement error using low-cost signal processing electronics. The correction is accomplished by comparing the received projectile speed data with parametric curves that are computed in a microprocessor, and selecting a set of two parametric curves that bound the received projectile data within a sufficiently narrow parametric range so that the initial projectile speed can be computed with the desired accuracy.

The preferred embodiment employs a simplified mathematical model of the real-world behavior of a ball moving through the air to generate the parametric bounding curves. The preferred, and example, embodiment corrects for the “cosine” measurement error. Other embodiments could include corrections for:
1. the effect of gravity on the overall speed of the ball,
2. the effect of air resistance which slows the speed of the ball over its trajectory and varies depending on the size of the ball and the atmospheric pressure, and
3. the effect of the spin of the ball, which can deflect it from a straight path.

Despite these limitations of the example method, a significant improvement in accuracy and consistency has been achieved in real-world testing of the model. Furthermore, changes to the “flight path” model to account for some or all of the above factors in subsequent embodiments does not invalidate the basic algorithmic method as applied to the “cosine” error. Applying theoretical correction equations for the other enumerated factors would result in similar error corrections accounting for these other factors, though they could add to the number of iterations required to obtain an optimal solution.

### BRIEF DESCRIPTION OF THE DRAWINGS

FIG. 1 is a diagram showing the geometry of the problem.

FIG. 2 shows the form of the cosine speed error.

FIG. 3 is a block diagram of low-cost Doppler radar unit.

FIG. 4 shows a typical Doppler radar signal from a pitched baseball.

FIG. 5 is a more detailed diagram of the geometry of the problem.

FIG. 6 is a plot of a truncated Doppler radar signal.

FIG. 7 shows the target signal and the first set of bounding curves.

FIG. 8 shows the target signal and the second set of bounding curves.

FIG. 9 shows the target signal and the third set of bounding curves.

FIG. 10 shows the target signal and the fourth set of bounding curves.

FIG. 11 shows a flowchart summarizing the method.

### MODES FOR CARRYING OUT THE INVENTION

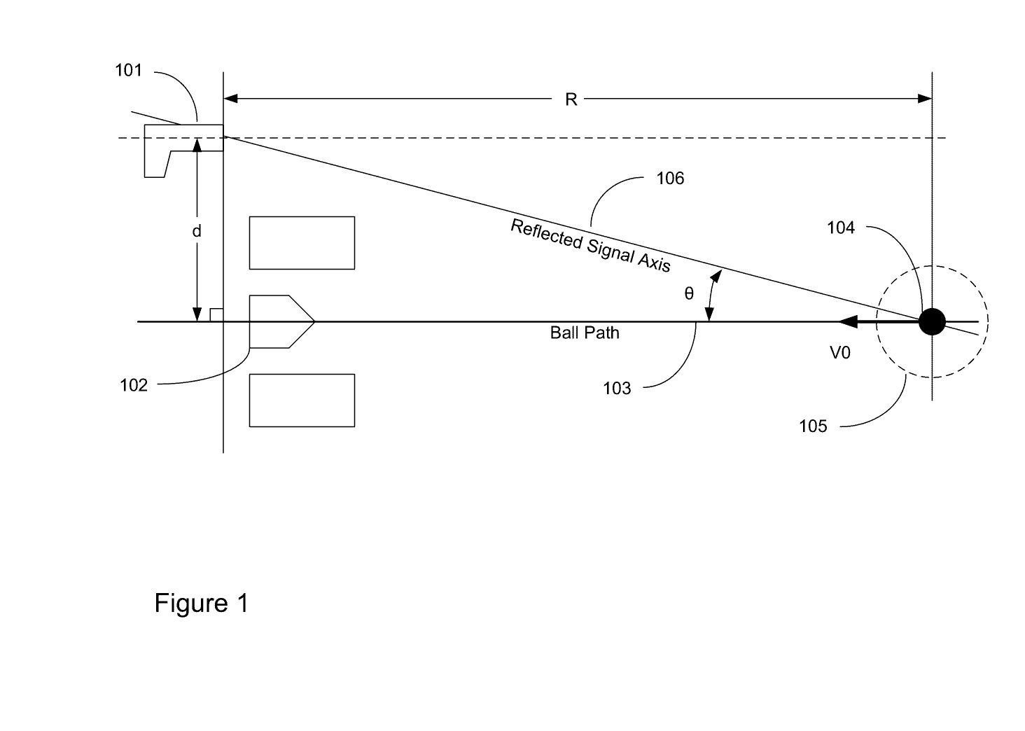

FIG. 1 is a diagram showing the geometry of the problem as it applies to the measurement of the speed of a pitched baseball. The Doppler radar unit 101 is assumed to be positioned behind and to one side of home plate 102 in order to avoid interference with the ball path 103. Doppler radar unit 101 is directed away from the home plate 102 area. Baseball 104 is released from the area of the pitcher's mound 105 and is assumed to travel along the ball path at constant speed V0. Radio signals from the Doppler radar unit 101 are reflected from the ball continuously as it traverses ball path 103 and enter the Doppler radar unit along reflected signal axis 106 which extends at an angle θ with respect to ball path 103. Reflected signal axis 106 and angle θ clearly change as the pitched baseball 104 traverses ball path 103. According to the Doppler effect, the speed measured at Doppler radar unit 101, Vm, differs from pitched baseball speed V0 according to

Vm(t)=V0*cos(θ(t)) (1)

where both Vm and θ are functions of elapsed time, t. Equation (1) is the theoretical correction equation for the correction of the “cosine” error due to the radar detector being located off-axis from the flight of the projectile whose speed is being measured.

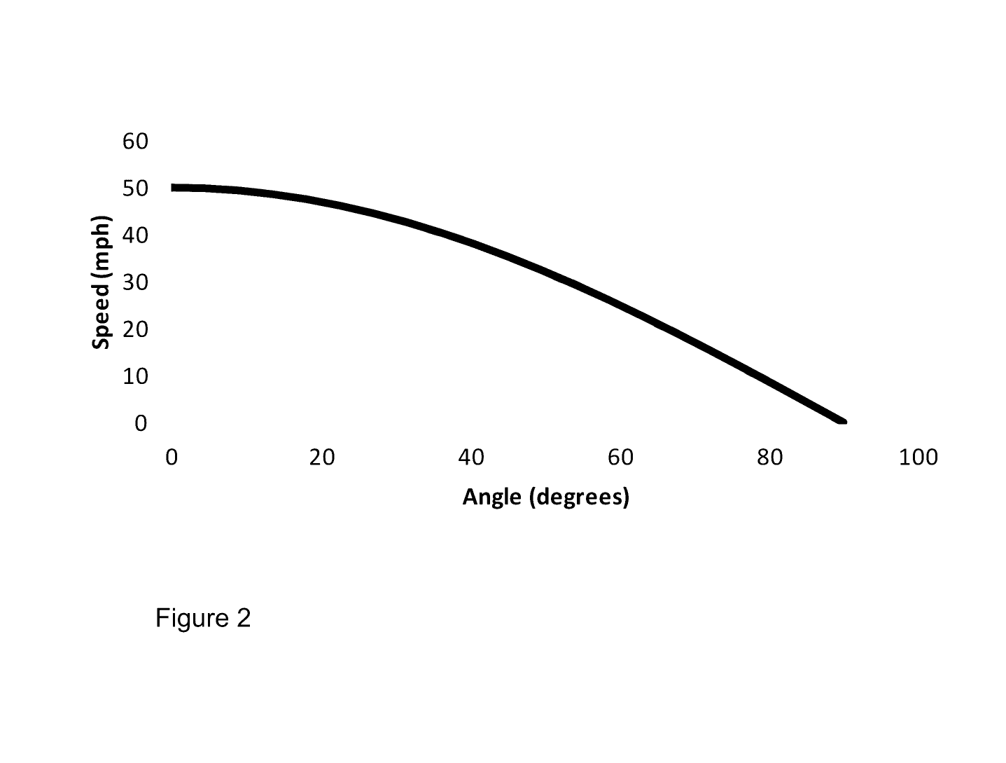

The amount by which Vm(t) differs from V0 is the so-called “cosine” error. FIG. 2 shows the form of the cosine speed error as a function of angle θ assuming V0 to be 50 mph. Of note is the fact that the measured speed vanishes when the reflected signal axis 106 is perpendicular to the ball path 103, for which θ=90 degrees.

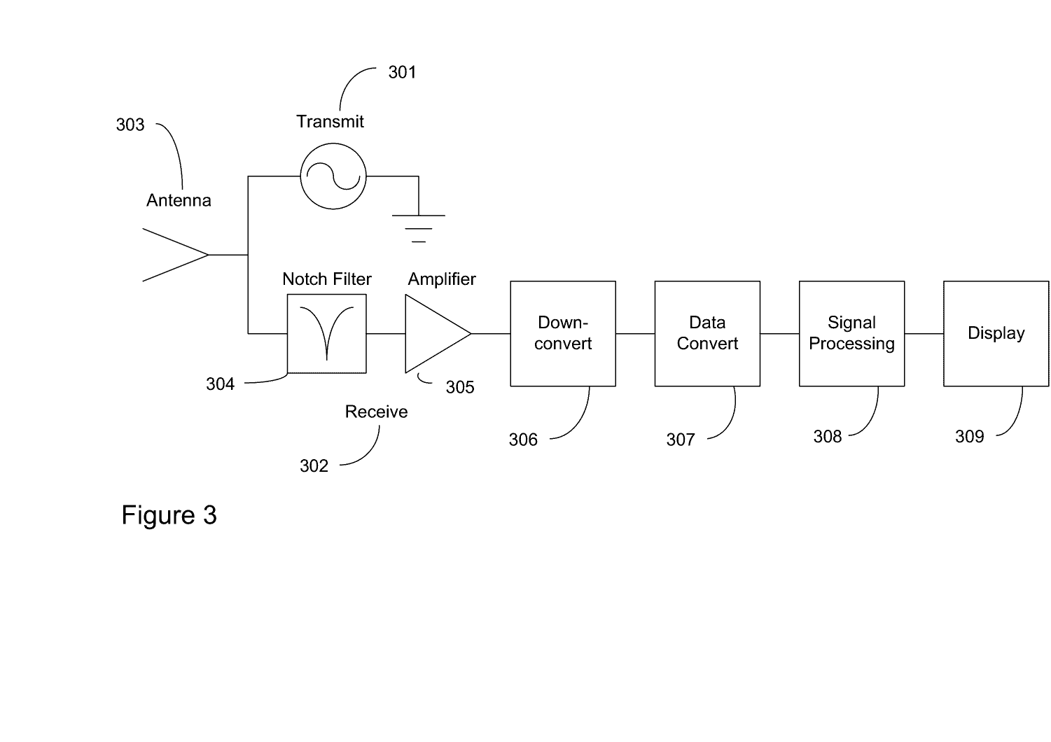

FIG. 3 is a block diagram of typical low-cost Doppler radar unit. Transmit 301 and receive 302 functions are connected to a common antenna unit 303 which both directs continuously radiated radio frequency energy and collects the radiated energy reflected from the desired moving target. The first element in the receive function 302 is typically a notch filter unit 304 that removes the strong radio frequency signal at the transmit frequency while allowing the Doppler-shifted frequency of the moving target to be applied to amplifier 305. The amplified Doppler-shifted signal is then down-converted to baseband in down-convertor 306.

The output signal from the down-convertor 306 is an analog sinusoidal signal at the Doppler offset frequency which is related to the transmit frequency, fₜᵣₐₙₛₘᵢₜ and the target speed, V, by

$${f}_{Doppler} = 2 V \frac{{f}_{transmit}}{c} \qquad ( 2 )$$

where c is the speed of light. For an X-band Doppler radar, fₜᵣₐₙₛₘᵢₜ is approximately 10 GHz, resulting in a Doppler frequency sensitivity (f_{Doppler}/V) of approximately 30 Hz/mph. Thus, a baseball launched at a speed of 50 mph would create a 1500 Hz Doppler signal at the output of the down-convertor 306. This signal is applied to the input of a data convertor 307 which functions to convert the analog Doppler waveform to a digital signal for subsequent digital signal processing. In its simplest form, the data convertor 307 is simply an analog-to-digital convertor running at a clock frequency substantially higher than the highest expected Doppler frequency. The output of the data convertor 307 is a binary representation of the Doppler signal waveform, and it is applied to the input of the signal processor 308.

The first function of the signal processor 308 is to derive a periodic binary representation of the Doppler signal frequency. One means to accomplish this function is to accumulate (add together) the binary Doppler signal values from the data convertor while maintaining a count of the number of samples accumulated. Since these values are samples of a sinusoidal signal, accumulation over one sinusoidal period must result in a value of zero. When a zero value is detected in the signal processor, the sample count is stored in memory, resulting in a binary representation of the period of the Doppler signal, hence the Doppler signal frequency, and the accumulator is reset. The target speed over the accumulated period can be calculated given the Doppler sensitivity, as illustrated above. The second function of the signal processor 308 is to prepare data for display to the user. In the simplest embodiment, the signal processor stores the largest value of computed speed over the observation interval and presents it to the display function 309 which displays the value on an alphanumeric display device. In the preferred embodiment the components of FIG. 3 are included in a single unit. In other embodiments the components may be located in separate units. In another embodiment the signal processing 308 and display 309 are located in a unit(s) physically separated from the components 301-307. In another embodiment there may be a plurality of detection components 301-307 connected to a single set of components 308 and 309. The latter embodiment may apply the methods taught here for correction of additional factors such as gravity, air resistance and curvature of the flight.

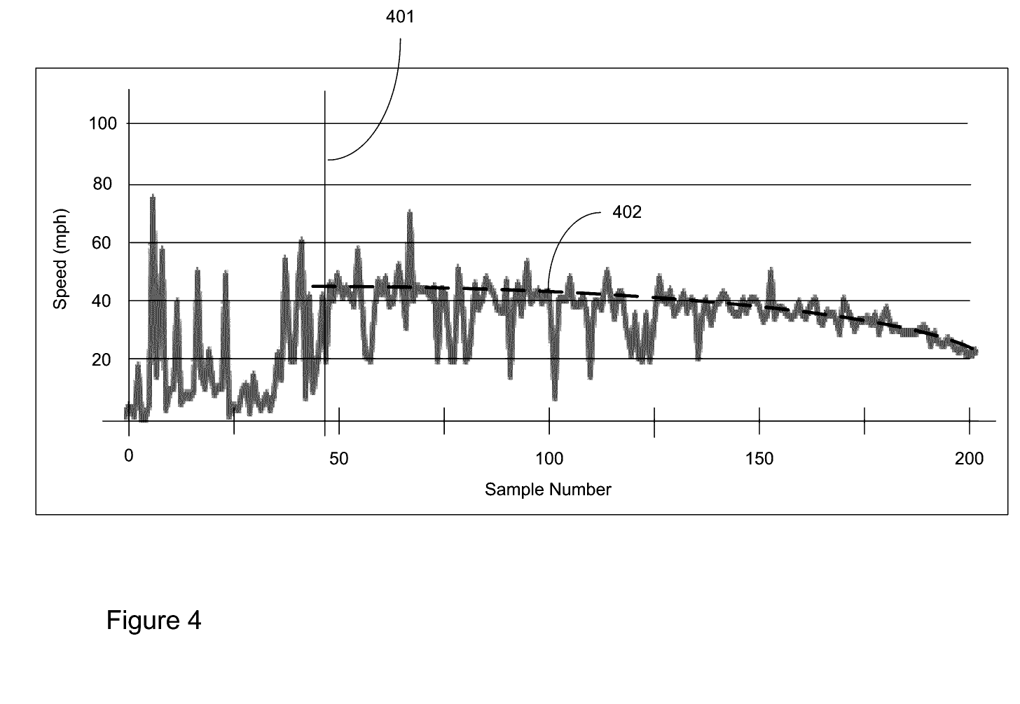

FIG. 4 shows a typical Doppler radar signal from a pitched baseball wherein the speed computed from the Doppler frequency is plotted versus sample number as provided by data convertor 307 in FIG. 3. The data indicate that the ball is released 401 at approximately sample number 48. The spurious data that occurs prior to ball release 401 is largely caused by the motion of the pitcher. Data from the ball continues until approximately sample number 200, where the ball passes outside the field of view of the radar unit. A smoothed curve 402 representing the Doppler signal that exhibits the “cosine” error, using the theoretical correction equation of Equation (1), is superimposed on the received data. The signal to noise ratio of the data clearly improves as the ball approaches the Doppler radar unit and the reflected signal increases in strength. It is clearly necessary to truncate the data derived from the Doppler signal in order to eliminate the spurious data occurring prior to ball release 401 and possibly the noisiest portion of the Doppler signal data if further signal processing is to be accomplished to correct the “cosine” error. It may also be desirable to smooth the truncated data set in order to reduce noise, although this must be done carefully to avoid distorting the “cosine error” time response. These truncation and smoothing operations are assumed to be accomplished in the signal processor 308.

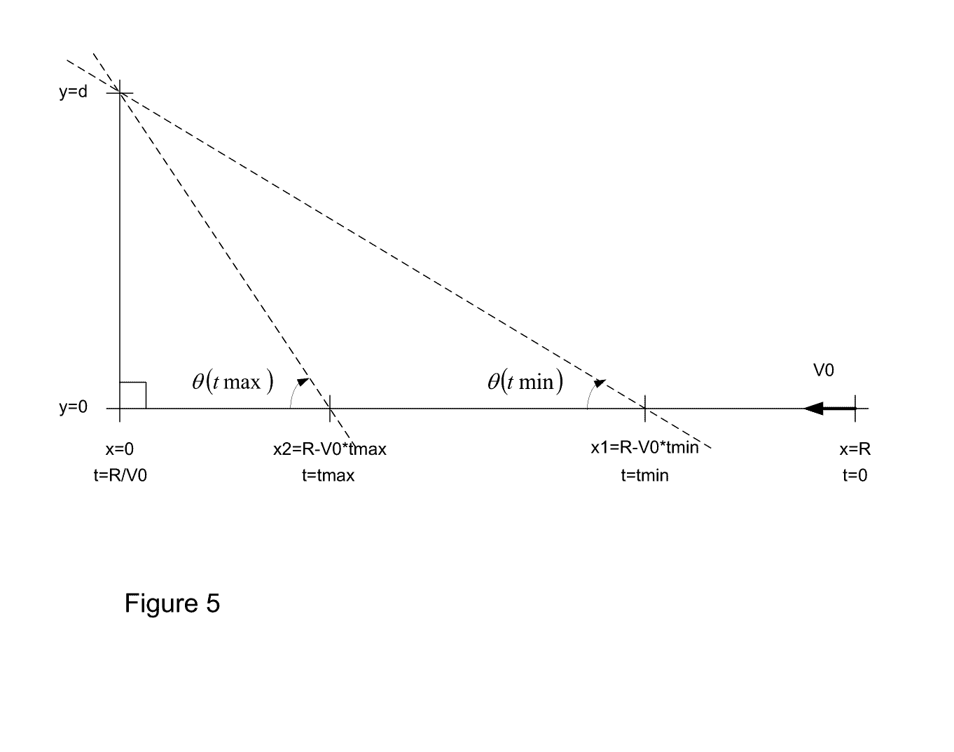

FIG. 5 shows a more detailed diagram of the geometry of the problem where it is assumed that the data record derived from the Doppler signal is to be truncated. The valid data record starts at time t=0 when the ball is released at range R and with speed V0. In this embodiment the ball is assumed to travel at constant speed along its trajectory on the x-axis. The Doppler radar unit is located at the origin of the x-axis and offset a distance d perpendicular to the x-axis. The x-coordinate of the ball is described by x(t)=R−V0*t. The angle, θ, between the x-axis and the path of the reflected radar signal is time dependent and is given by

$$θ ( t ) = {tan}^{- 1} ( \frac{d}{x ( t )} ) \qquad ( 3 )$$

for which

$$cos θ ( t ) = \frac{x ( t )}{\sqrt{{x}^{2} ( t ) + {d}^{2}}} . \qquad ( 4 )$$

Thus, the measured velocity is given by

$$Vm ( t ) = V 0 * \frac{R - V 0 * t}{\sqrt{{( R - V 0 * t )}^{2} + {d}^{2 }}} . \qquad ( 5 )$$

Note that this selection of coordinate axes results in θ(x=0)=90°, so that Vm(x=0)=0.

The data record is to be truncated before t=tmin and after t=tmax. A simple coordinate transformation to t′=t−tmin gives

$$Vm ( {t}^{′} ) = V 0 * \frac{L - V 0 * {t}^{′}}{\sqrt{{( L - V 0 * {t}^{′} )}^{2} + {d}^{2}}} \qquad ( 6 )$$

where L=R−V0*tmin. Rearranging terms and dropping the primed notation yields

$$Vm ( t ) = V 0 * \frac{1 - \frac{V 0}{L} * t}{\sqrt{{( 1 - \frac{V 0}{L} * t )}^{2} + {( \frac{d}{L} )}^{2}}} \qquad ( 7 )$$

where it is understood that time is measured with respect to tmin. Thus, a complete mathematical description of a time record of the measured speed from a Doppler radar unit over a given time period requires the knowledge of the values of the parameters V0, V0/L and d/L. Note that the quantity L/V0 is the time interval required for the ball to travel from x=R−V0*tmin to x=0, while the dimensionless quantity d/L is simply tan(θ(tmin)).

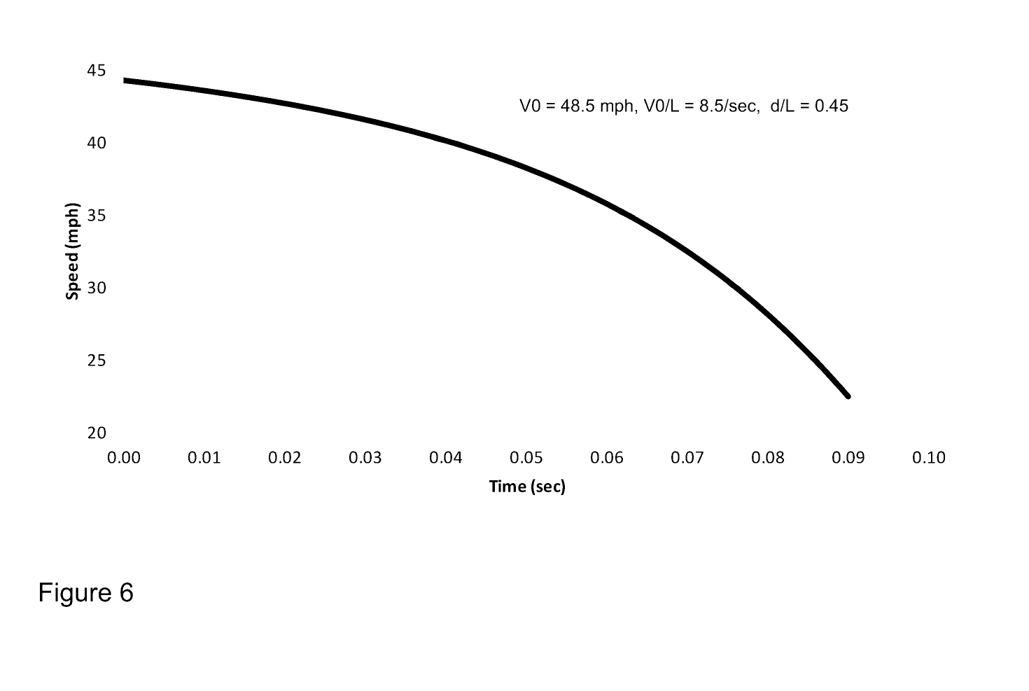

FIG. 6 is a plot of a truncated Doppler radar signal synthesized using the equation above and adjusted to approximate the smoothed data from that shown earlier in FIG. 4. For this example data vector the parameters used were V0=48.5 mph, V0/L=8.5 (L/V0=118 msec), and d/L=0.45. The incremental time value for each speed value in the data record can be obtained from the equation relating the Doppler frequency to the radar frequency and is assumed to be one period at the Doppler frequency. This example will be used as a target case in the following discussions.

The revised second function of the signal processor 308 in FIG. 3 is to compute an estimate of the initial speed of the pitched baseball along the ball path, thus correcting the “cosine error.” Rather than attempting to fit a curve to the target data vector which requires complex numerical computation, the inventive method involves generating an iterative sequence of theoretical curves from the relationship for Vm(t), Equation (7), as described above, that “bound” the target data vector. The bounding curves are refined iteratively to narrow the ranges of the affected parameters until the desired accuracy is achieved. To see how this method works, we return to Equation (7) for the measured velocity and note that the measured quantity Vm0=Vm(t=0) is simply related to V0 by

$$Vm 0 = V 0 * \frac{1}{\sqrt{1 + {( \frac{d}{L} )}^{2}}} , \qquad ( 8 )$$

so that we can substitute for V0 in Equation (7) to give

$$Vm ( t ) = Vm 0 * \frac{( 1 - \frac{V 0}{L} * t ) * \sqrt{1 + {( \frac{d}{L} )}^{2}}}{\sqrt{{( 1 - \frac{V 0}{L} * t )}^{2} + {( \frac{d}{L} )}^{2}}} \qquad ( 9 )$$

which now depends only on the parameters V0/L and d/L. Also, since from Equation (8)

$$V 0 = Vm 0 * \sqrt{1 + {( \frac{d}{L} )}^{2}} \qquad ( 10 )$$

we arrive at the desired value of V0 as soon as a sufficiently accurate estimate of d/L is obtained. From this result it is easily shown that the accuracy in the value of V0 so obtained is related to the accuracy in the value of d/L by

$$\frac{δ V 0}{V 0} = \frac{{( \frac{d}{L} )}^{2}}{1 + {( \frac{d}{L} )}^{2}} * \frac{δ ( \frac{d}{L} )}{\frac{d}{L}} . \qquad ( 11 )$$

Thus, for example, in order to obtain an accuracy of 1 mph in V0 with V0 around 50 mph and with d/L approximately equal to ½ (typical values) a fractional accuracy of about 10% in d/L is adequate.

In order to obtain estimates for the remaining parameters V0/L and d/L to begin the iterative process, consider the expression for the measured quantity Vm(tmax) which is obtained from Equation (9):

$$Vm ( t max ) = Vm 0 * \frac{( 1 - \frac{V 0}{L} * t max ) * \sqrt{1 + {( \frac{d}{L} )}^{2}}}{\sqrt{{( 1 - \frac{V 0}{L} * t max )}^{2} + {( \frac{d}{L} )}^{2}}} . \qquad ( 12 )$$

This equation can be solved for d/L to yield

$$\frac{d}{L} = \sqrt{\frac{Vm {0}^{2} - {Vm ( t max )}^{2}}{[ {( \frac{Vm ( t max )}{1 - \frac{V 0}{L} * t max} )}^{2} - Vm {0}^{2} ]} .} \qquad ( 13 )$$

Since d/L must be real, the denominator in the fraction under the radical must be positive, thus requiring that

$$\frac{V 0}{L} > \frac{1 - \frac{Vm ( t max )}{Vm 0}}{t max} \qquad ( 14 )$$

which provides a lower bound on the parameter V0/L. However, once an estimate for V0/L is obtained, Equation (13) can be used to obtain an estimate for d/L. For the target data vector shown in FIG. 6, we have Vm0=44.23 mph and Vm(tmax)=22.45 mph. Thus the lower bound on V0/L is 0.492/tmax and we can choose the first set of bounding curves to correspond to V0/L=0.5/tmax and V0/L=1.0/tmax. Anticipating that V0/L will fall between these values, we evaluate the expression for the estimate of d/L at the midpoint, V0/L=0.75/tmax to obtain the estimate d/L=0.488.

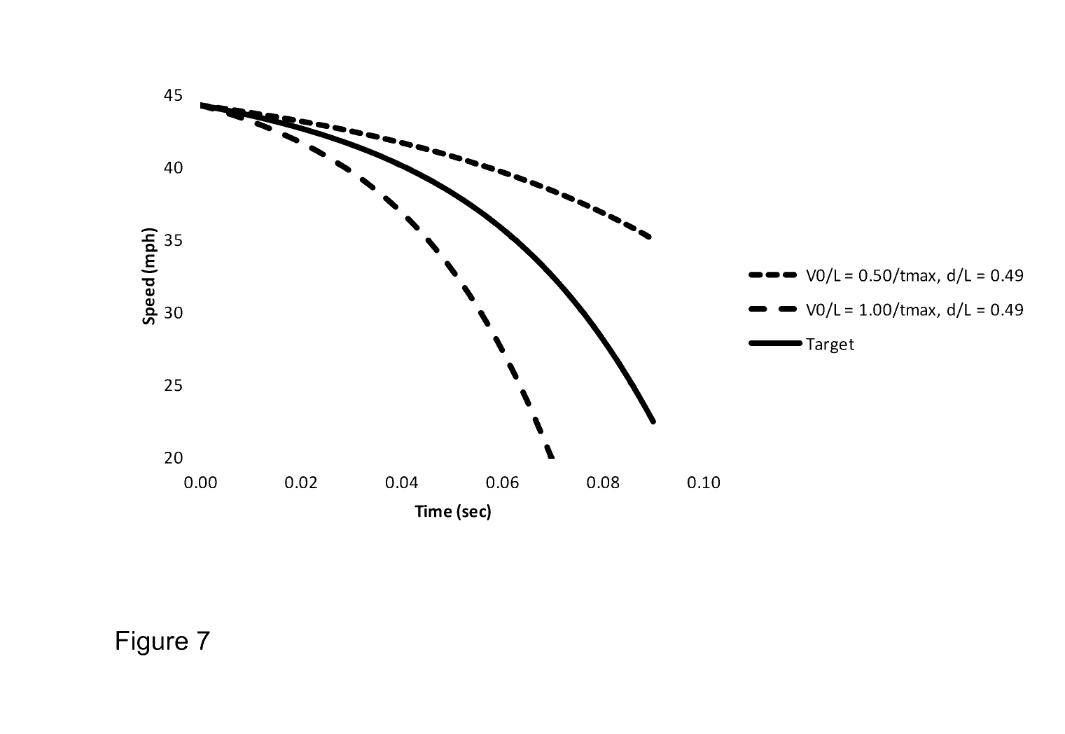

FIG. 7 shows the target signal and the first set of two bounding curves. The target curve falls well between the bounding curves, so we proceed to the next iteration with the estimate V0/L=0.75/tmax. Had the target curve fallen outside the bounding curves, we would increase the range of the curves and repeat the iteration. One non-limiting approach to establishing the extent to which the target is bounded by the bounding curves is to enumerate the number of data samples for which the target value exceeds the bounding curve value for each bounding curve. The lower bounding curve is then the curve for which the number of data samples so enumerated is large, while the upper bounding curve is the curve for which the number of enumerated data samples is very small.

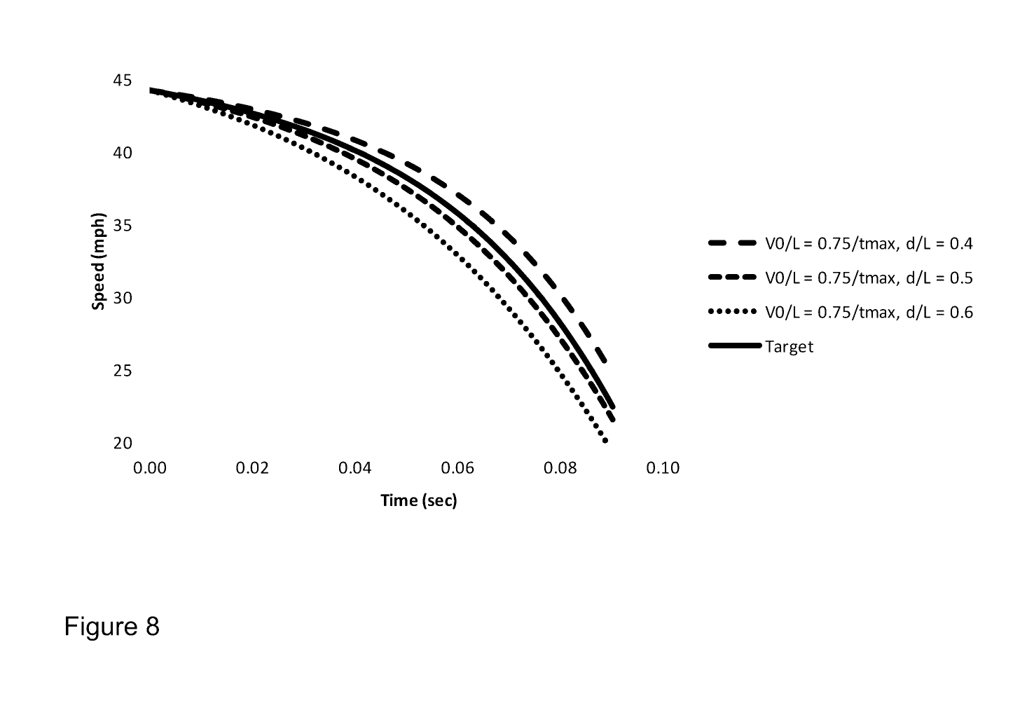

We now test the value of d/L by producing bounding curves that bracket the initial estimate and choose the three values d/L=0.4, d/L=0.5 and d/L=0.6. FIG. 8 shows the target signal and the second set of three bounding curves. The target falls between the bounding curves for d/L=0.4 and d/L=0.5 yielding an updated estimate of d/L=0.45. The accuracy in the value of V0 (δV0/V0) established by Equation (11) using these bounds on d/L is 4%, so a need for further iteration is indicated. For the next iteration we choose d/L=0.45 and examine the range of values for V0/L: V0/L=0.725/tmax, 0.75/tmax and 0.775/tmax.

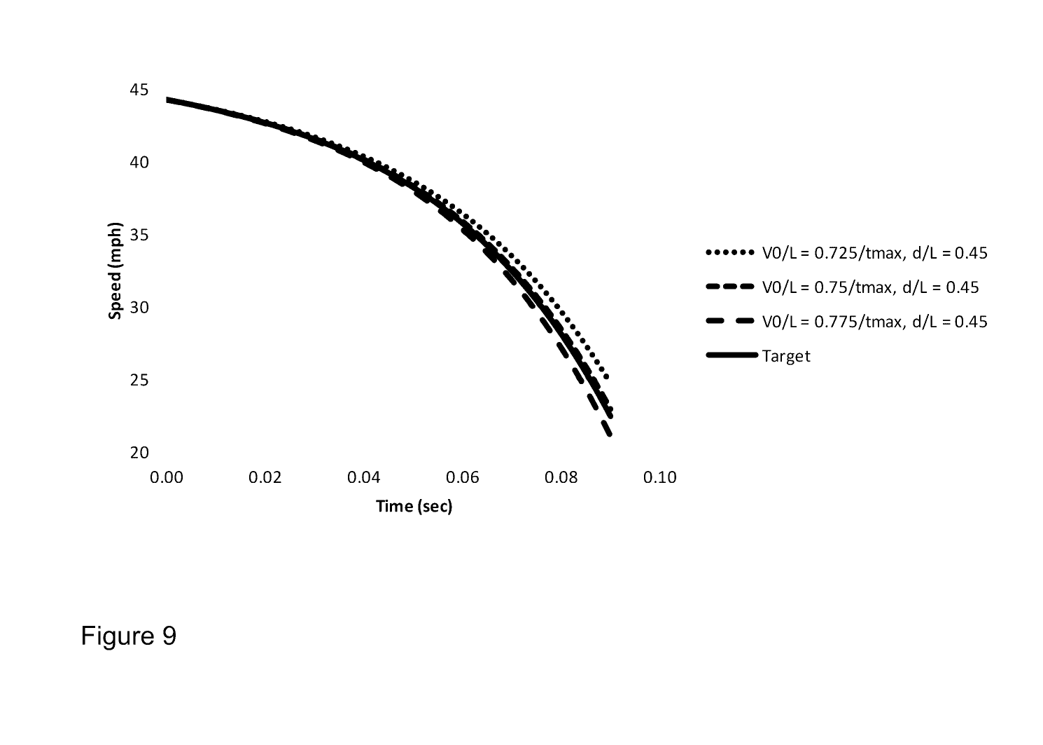

FIG. 9 shows the target signal and the third set of three bounding curves. The target curve is found to fall between the bounding curves for V0/L=0.75/tmax and 0.775/tmax, so for the next iteration we choose V0/L=0.7625/tmax and examine the range of values for d/L: d/L=0.42, 0.45 and 0.48.

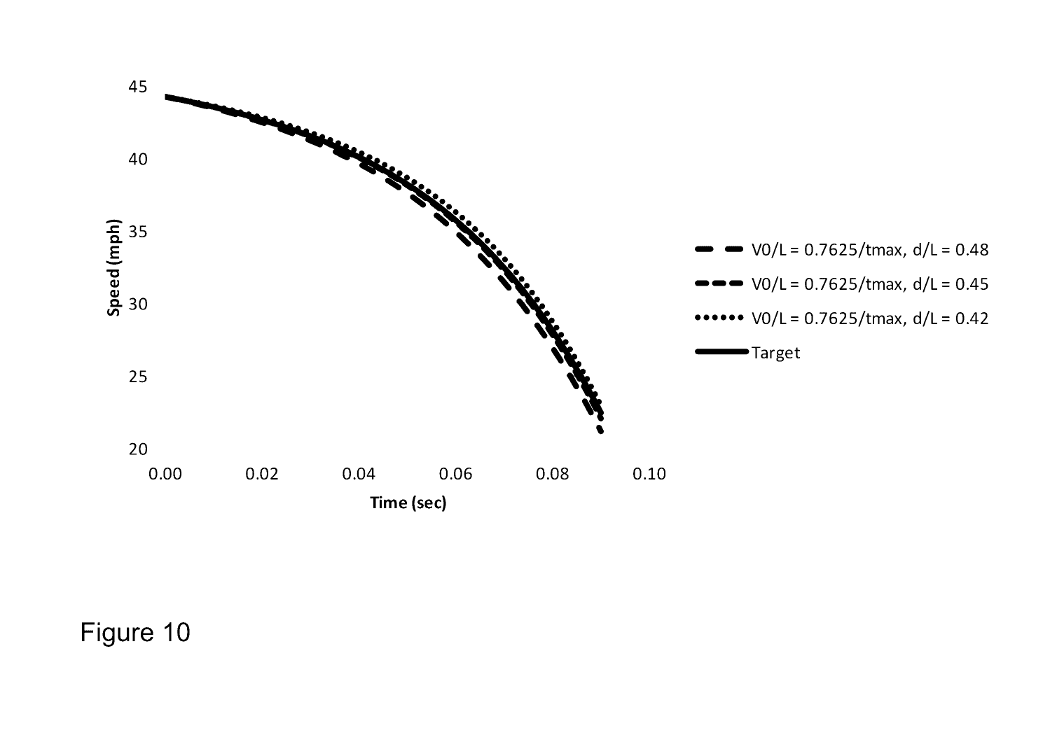

FIG. 10 shows the target signal and the fourth set of three bounding curves. The target curve falls between the bounding curves for d/L=0.42 and d/L=0.45 giving an updated estimate of d/L=0.435. The resulting accuracy in V0 is found to be 1% which is adequate. The resulting value of V0 is calculated to be 48.2 mph compared to a target value of 48.5 mph, which is well within the desired accuracy.

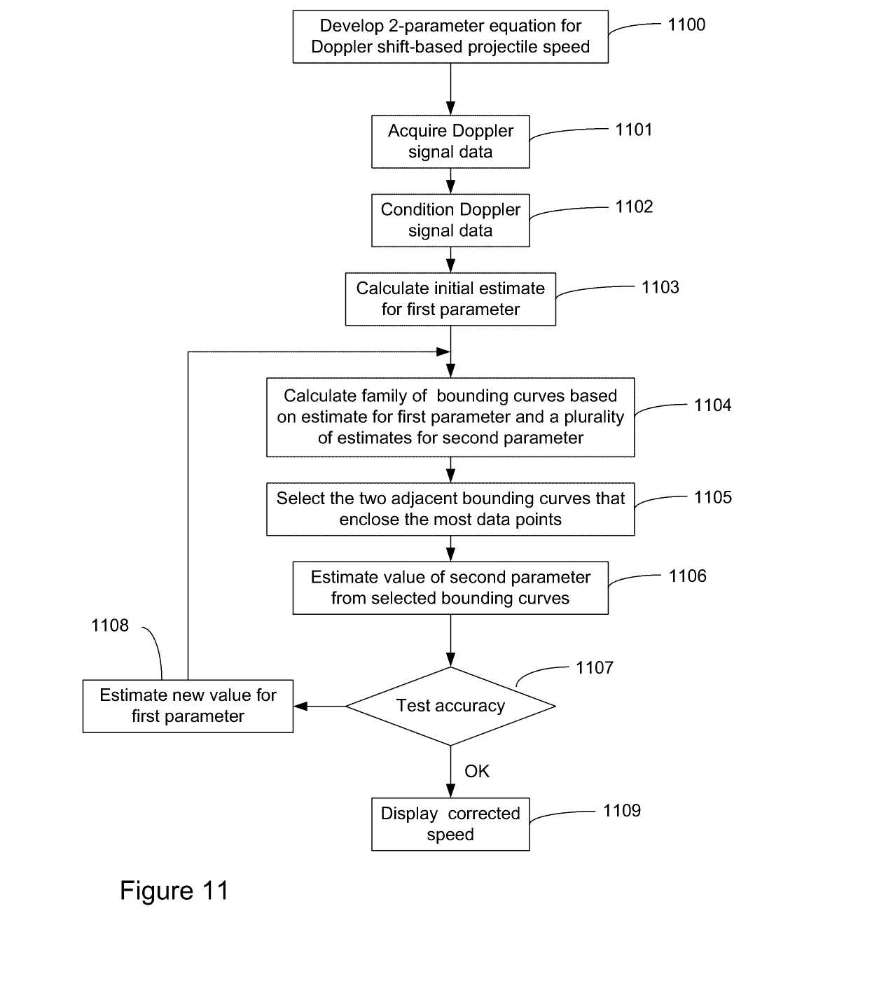

FIG. 11 shows a flowchart that summarizes the key steps comprising the inventive method. The method is based on the development of a theoretical equation 1100 having at most two parameters that allows prediction of the Doppler shift-based projectile speed. Given this prerequisite, Doppler data is acquired 1101 from the radar unit and conditioned 1102 by smoothing and truncating the time record. An initial estimate of the first parameter is obtained 1103 and used to calculate a family of bounding curves 1104 using the equation developed in 1100 and based on a plurality of estimates for the second parameter. Two adjacent bounding curves are selected 1105 that enclose the most Doppler data points, and an estimate for the second parameter 1106 is obtained. The accuracy of the estimated solution for the projectile speed is checked 1107. If the accuracy is sufficient, the estimated value is displayed 1109. Otherwise, a new estimate for the first parameter is obtained 1108 and the steps in 1104-1107 are repeated.

Using this method, the computation and comparison of only 11 bounding curves was required to achieve the desired result in the ideal case presented in FIGS. 7-10. In practice, more iterations may be required to overcome excess noise or secondary effects in the trajectory of the pitched baseball, but it is unlikely that more than a few dozen iterations will be required in any case. The computational load associated with this task is well within the capabilities of low cost microprocessor units operating at low clock frequencies to conserve power. Although shown with the preferred embodiment of correcting for the “cosine” error that occurs when the radar detector is not aligned with the trajectory of the projectile, the same iterative procedure may be used to improve the accuracy of a Doppler measured speed where a two-parameter theoretical equation applies.

### SUMMARY

A method is described for correcting Doppler shift-based measurements of the speed at which a sports projectile—such as a baseball, a tennis ball or a hockey puck—is delivered by an athlete, resulting in a more accurate measurement of that speed. Specifically, the well-known “cosine” measurement error endemic in Doppler shift-based speed measurements is corrected using low-cost signal processing electronics. The correction is accomplished by comparing the received projectile speed data with parametric curves that are computed in a microprocessor, and selecting a set of two parametric curves that bound the received projectile data within a sufficiently narrow parametric range so that the initial projectile speed can be computed with the desired accuracy.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. A method for determining the speed of a projectile using a radar signal acquired by a radar speed detector said detector having an axis of detection and said projectile having a velocity axis, said detector further providing Doppler signal data from said projectile, said method comprising:
a. acquire a plurality of Doppler signal data points for a plurality of times as the projectile approaches the radar detector, each data point indicating a measured speed of the projectile,
b. truncate the plurality of Doppler signal data points by removing points at the earliest times and the latest times, points removed selected for times before the projectile is detected and for times after the projectile has passed the detector, thereby producing truncated data,
c. develop an equation for computing the speed of the projectile requiring at most two independent parameters,
d. calculate an estimated value for the first parameter in the equation for the speed of the projectile from the truncated data,
e. calculate a plurality of bounding curves said curves being data of speed and time and based upon the estimated value of the first parameter and a plurality of estimates for the value of the second parameter in the equation,
f. select two of the bounding curves from the plurality of bounding curves said two curves selected from the plurality of bounding curves as those two that include within their bounds the maximum number of data points of the truncated data and the minimum difference in the estimates of the second parameter,
g. estimate the value of the second parameter as the midpoint of the estimated values of the second parameter for the two selected bounding curves,
h. estimate a new value for the first parameter based upon the estimated value of the second parameter,
i. iteratively estimate the values of the first and second parameters by repeating steps d-h until a converged value is obtained for the estimated speed.

2. The method of claim 1 wherein said first said parameter is the transit time of the projectile, extending from the earliest truncated time value to a time value at which the projectile passes the position of the detector along the velocity axis, and second said parameter is the tangent of the angle between the axis of detection and the velocity axis at the earliest truncated time value.

3. The method of claim 1 wherein first said parameter is the initial speed of the projectile and the second said parameter is the tangent of the angle between the axis of detection and the velocity axis at the earliest truncated time value.

4. A system for measuring the speed of a projectile, said system comprising a radar system comprising a transmitter and a detector for radar signals and a first signal processor providing Doppler signal data from moving targets and a second signal processor programmed to compute the speed of the projectile from the Doppler signal data according to the method of claim 1.

5. The system of claim 4 wherein the transmitter, detector, first signal processor and second signal processor are incorporated within a single unit.

6. The system of claim 4 wherein the transmitter, detector and first signal processor are contained in a first unit and the second signal processor is contained in a second unit.

7. The method of claim 1 wherein the estimate for the new value of the first parameter in step h is obtained by
a. calculate a plurality of bounding curves said curves being data of speed and time and based upon the estimated value of the second parameter and a plurality of estimates for the value of the first parameter in the said equation,
b. select two of the bounding curves from the plurality of bounding curves said two curves selected from the plurality of bounding curves as those two that include within their bounds the maximum number of data points of the truncated data and the minimum difference in the estimates of the first parameter, and
c. estimate the value of the first parameter as the midpoint of the estimated values of the first parameter for the two selected bounding curves.

8. The method of claim 7 wherein said first said parameter is the transit time of the projectile, extending from the earliest truncated time value to a time value at which the projectile passes the position of the detector along the velocity axis, and second said parameter is the tangent of the angle between the axis of detection and the velocity axis at the earliest truncated time value.

9. The method of claim 7 wherein first said parameter is the initial speed of the projectile and the second said parameter is the tangent of the angle between the axis of detection and the velocity axis at the earliest truncated time value.

10. A system for measuring the speed of a projectile, said system comprising a radar system comprising a transmitter and a detector for radar signals and a first signal processor providing Doppler signal data from moving targets and a second signal processor programmed to compute the speed of the projectile from the Doppler signal data according to the method of claim 7.

11. The system of claim 10 wherein the transmitter, detector, first signal processor and second signal processor are incorporated within a single unit.

12. The system of claim 10 wherein the transmitter, detector and first signal processor are contained in a first unit and the second signal processor is contained in a second unit.
